(19) United States
(12) Patent Application Publication
(10) Pub. No.: US 2025/0285395 A1
(43) Pub. Date: Sep. 11, 2025

(54) SUB-APPLICATION PROCESSING

(71) Applicant: TENCENT TECHNOLOGY (SHENZHEN) COMPANY LIMITED, Shenzhen (CN)

(72) Inventors: Tianyu DAI, Shenzhen (CN); Zhenpeng YE, Shenzhen (CN); Xinyi ZHOU, Shenzhen (CN)

(73) Assignee: TENCENT TECHNOLOGY (SHENZHEN) COMPANY LIMITED, Shenzhen, GD (CN)

(21) Appl. No.: 19/219,680

(22) Filed: May 27, 2025

Related U.S. Application Data
(63) Continuation of application No. PCT/CN2024/082397, filed on Mar. 19, 2024.

(30) Foreign Application Priority Data
May 6, 2023 (CN) 202310504686.7

(51) Int. Cl. G06T 19/00; G06F 9/451; G06T 13/20

(52) U.S. Cl. CPC G06T 19/006; G06F 9/451; G06T 13/20

(57) ABSTRACT

A page structure file is obtained for a sub-application, the page structure file describes a structure of an extended reality interactive page. The page structure file is parsed to obtain one or more predefined labels. The one or more predefined labels respectively include an indicator of extended reality. The one or more predefined labels are respectively converted into one or more elements in an extended reality interactive framework. Respective attribute information of the one or more predefined labels are obtained from the page structure file. The respective attribute information of the one or more predefined labels are converted into respective component information for the one or more elements in the extended reality interactive framework. The extended reality interactive page for the sub-application is generated based on the one or more elements in the extended reality interactive framework and the respective component information for the one or more elements.

### RELATED APPLICATIONS

The present application is a continuation of International Application No. PCT/CN2024/082397, filed on Mar. 19, 2024, which claims priority to the Chinese patent application No. 202310504686.7, filed on May 6, 2023. The entire disclosures of the prior applications are hereby incorporated by reference.

### FIELD OF THE TECHNOLOGY

This disclosure relates to the field of computer technologies, including a sub-application processing technique.

### BACKGROUND OF THE DISCLOSURE

With the development of computer technologies, an increasing number of applications provide convenience for users' work and life. The applications may alternatively be parent applications and sub-applications. The parent applications refer to applications that can run independently. The sub-applications refer to applications that can be used without the need to be downloaded or installed. However, the sub-applications need to be run on the parent applications.

Currently, there is a sub-application development scheme that is open to users, so that the users can develop custom sub-applications. For example, businesses on an internet of things develop dedicated sub-applications to provide services to consumers.

However, at present, custom development of small programs often requires more pre-knowledge. In a development process of sub-applications for extended reality interactions, it is necessary to introduce third-party rendering engines, and then integrate them with visual positioning capabilities of the sub-applications for algorithm docking, which requires developers to have relevant knowledge of the third-party rendering engines. This makes a threshold for sub-application development relatively high.

### SUMMARY

According to embodiments of this disclosure, a sub-application processing method, device, computer apparatus, computer-readable storage medium and computer program product is provided.

Some aspects of the disclosure provide a method of sub-application processing. In some examples, a page structure file is obtained for a sub-application, the page structure file describes a structure of an extended reality interactive page to be generated for the sub-application. The page structure file is parsed to obtain one or more predefined labels in the page structure file. The one or more predefined labels respectively include an indicator of extended reality. The one or more predefined labels are respectively converted into one or more elements in an extended reality interactive framework. Respective attribute information of the one or more predefined labels are obtained from the page structure file. The respective attribute information of the one or more predefined labels are converted into respective component information for the one or more elements in the extended reality interactive framework. The extended reality interactive page for the sub-application is generated based on the one or more elements in the extended reality interactive framework and the respective component information for the one or more elements. The extended reality interactive page displays interactions between a real scene and a virtual scene.

Some aspects of the disclosure provide an information processing apparatus configured to perform the method of sub-application processing.

According to one aspect, this disclosure provides a sub-application processing method, executed by a computer apparatus, where the method includes: obtaining a page structure file corresponding to a sub-application, wherein the page structure file is configured for describing a structure of an extended reality interactive page to be generated for the sub-application; parsing the page structure file to obtain each predefined label in the page structure file, and converting each predefined label into an element in an extended reality interactive framework; obtaining attribute information corresponding to each predefined label from the page structure file; for each predefined label, converting the attribute information corresponding to the predefined label into component information bound to the element converted from the predefined label; and generating the extended reality interactive page for the sub-application based on each element in the extended reality interactive framework and the component information bound to each element, the extended reality interactive page being configured for displaying interactions between a real scene and a virtual scene.

According to another aspect, this disclosure further provides a sub-application processing device. The device includes an obtaining module, an element generation module, a component information generation module, and a page generation module. The obtaining module is configured to obtain a page structure file corresponding to a sub-application. The page structure file is configured for describing a structure of an extended reality interactive page to be generated for the sub-application. The element generation module is configured to: parse the page structure file to obtain a predefined label in the page structure file, and convert the predefined label into an element in an extended reality interactive framework. The component information generation module is configured to: obtain attribute information corresponding to the predefined label from the page structure file; and for each predefined label, convert the attribute information corresponding to the predefined label into component information bound to the element converted from the predefined label. The page generation module is configured to generate the extended reality interactive page for the sub-application based on the element in the extended reality interactive framework and the component information bound to the element, the extended reality interactive page being configured for displaying interactions between a real scene and a virtual scene.

According to another aspect, this disclosure further provides a computer apparatus. The computer apparatus includes a memory and a processor (an example of processing circuitry). The memory stores a computer program, and when executing the computer program, the processor implements operations of each method embodiment of this disclosure.

According to another aspect, this disclosure further provides a computer-readable storage medium (e.g., non-transitory computer-readable storage medium). The computer-readable storage medium stores a computer program therein. The computer program, when executed by a processor, implements operations of each method embodiment of this disclosure.

According to another aspect, this disclosure further provides a computer program product. The computer program product includes a computer program. The computer program, when executed by a processor, implements operations of each method embodiment of this disclosure.

Details of one or more embodiments of this disclosure are set forth in the accompanying drawings and the description below. Other features and advantages of this disclosure will be apparent from the description, drawings and claims.

### BRIEF DESCRIPTION OF THE DRAWINGS

FIG. 1 is an application environment diagram of a sub-application processing method according to an embodiment.

FIG. 2 is a schematic flowchart of a sub-application processing method according to an embodiment.

FIG. 3 is a schematic diagram of codes for customizing components according to an embodiment.

FIG. 4 is a schematic diagram of codes for calling customized components according to another embodiment.

FIG. 5 is a schematic flowchart of converting attribute information corresponding to each predefined label into component information bound to a corresponding element according to an embodiment.

FIG. 6 is a schematic diagram of transmitting component configuration data to a system corresponding to the component according to an embodiment.

FIG. 7 is a schematic flowchart of driving each system to perform processing of received component configuration data to form corresponding page content, to obtain an extended reality interactive page for a sub-application according to an embodiment.

FIG. 8 is a schematic diagram of converting each predefined label in a page structure file into an element in an extended reality interactive framework according to an embodiment.

FIG. 9 is an extended reality interactive page of a sub-application according to an embodiment.

FIG. 10 is a schematic diagram of an architecture of a sub-application processing method according to an embodiment.

FIG. 11 is a schematic diagram of writing a wxml file according to an embodiment.

FIG. 12 is a schematic diagram of writing a js file according to an embodiment.

FIG. 13 is a schematic diagram of an extended reality interactive effect achieved by a wxml file and a js file combined with an extended reality interactive framework according to an embodiment.

FIG. 14 is a block diagram of a structure of a sub-application processing device according to an embodiment.

FIG. 15 is a diagram of an inner structure of a computer apparatus according to an embodiment.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

The embodiments of this disclosure can be applied to various scenes, including, but not limited to, cloud technology, artificial intelligence, intelligent transportation, assisted driving and other scenes. For example, the embodiments of this disclosure can be applied to the field of artificial intelligence (AI) technology. The Artificial Intelligence is a theory, method, technology and application system that uses digital computers or machines controlled by the digital computers to simulate, extend and expand human intelligence, perceive the environment, acquire knowledge and use the knowledge to obtain the best results. In other words, the artificial intelligence is a comprehensive technology of computer science that seeks to understand the nature of intelligence and produce a new kind of intelligent machine that can react in a similar way to human intelligence. The Artificial Intelligence is the study of design principles and implementation methods of various intelligent machines, enabling the machines to have the functions of perception, reasoning and decision-making. A scheme provided by the embodiments of this disclosure involves a sub-application processing method of the Artificial Intelligence, which is specifically illustrated in the following embodiments.

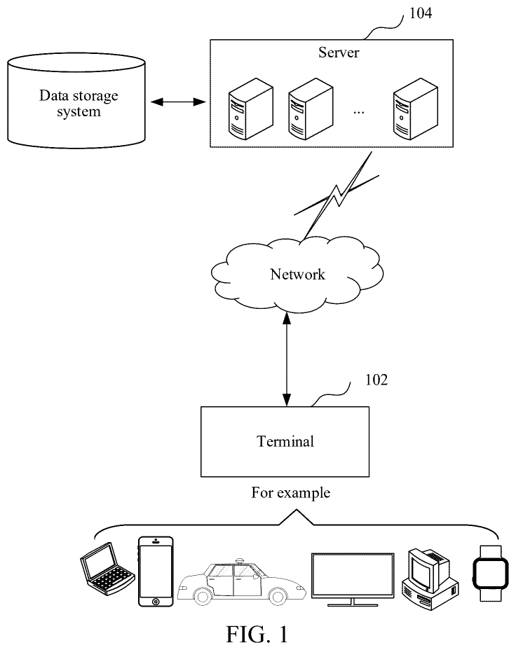

The sub-application processing method provided in the embodiments of this disclosure may be applied to an application environment shown in FIG. 1. A terminal 102 communicates with a server 104 over the network. A data storage system can store data that the server 104 needs to process. The data storage system can be integrated on the server 104 or placed on a cloud or on another server. The terminal 102 obtains a page structure file corresponding to a sub-application, where the page structure file is configured for describing a structure of an extended reality interactive page to be generated for the sub-application. The terminal 102 transmits the page structure file to the server 104. The server 104 parses the page structure file to obtain each predefined label in the page structure file, and converts each predefined label into an element in an extended reality interactive framework (also referred to as an extended reality interactive frame in some examples). The server 104 obtains attribute information corresponding to each predefined label from the page structure file. For each predefined label, the server converts the attribute information corresponding to each predefined label into component information bound to the element converted from the predefined label. The server 104 generates the extended reality interactive page for the sub-application based on each element in the extended reality interactive framework and the component information bound to each element. The sub-application is run on a parent application. The parent application is run on the terminal 102. The extended reality interactive page is configured for displaying interactions between a real scene and a virtual scene when the sub-application is run. The terminal 102 may be, but not limited to, a variety of desktop computers, laptops, smart phones, tablets, Internet of Things apparatuses and portable wearable apparatuses. The Internet of Things apparatuses may be smart speakers, smart TVs, smart air conditioners, smart in-vehicle apparatuses, etc. The portable wearable apparatuses may be smart watches, smart bracelets, headsets, etc. The server 104 can be implemented as a stand-alone server or as a cluster of multiple servers.

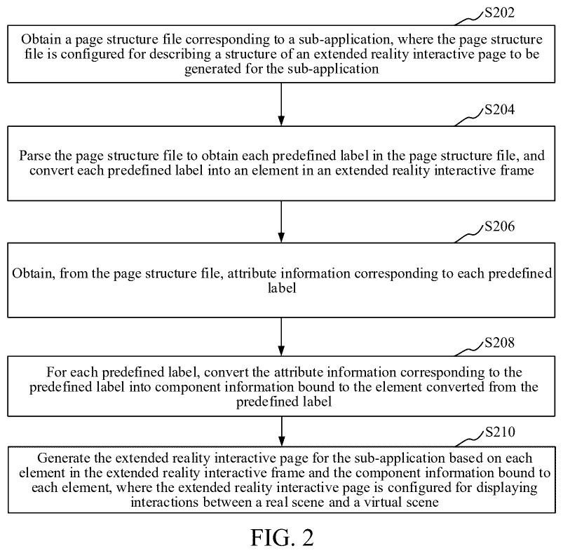

In one embodiment, as shown in FIG. 2, a sub-application processing method is provided, illustrated as an example of the method applied in FIG. 1 (a computer apparatus may be the terminal or server in FIG. 1), including the following operations.

In operation S202, a page structure file corresponding to a sub-application is obtained, where the page structure file is configured for describing a structure of an extended reality interactive page to be generated for the sub-application.

Examples of terms involved in the aspects of the disclosure are briefly introduced. The descriptions of the terms are provided as examples only and are not intended to limit the scope of the disclosure.

The sub-application refers to an application that cannot be run independently and needs to be run with the help of other applications. The parent application refers to an application that can be run independently and is capable of providing a running environment for the sub-application.

The page structure file is configured for describing the structure of the extended reality interactive page to be generated for the sub-application. The extended reality interactive page to be generated refers to an extended reality interactive page that needs to be generated. The extended reality interactive page is a page that enables the interactions between the real scene and the virtual scene. The page structure file can be a wxml file for the sub-application. The WeiXin Markup Language (wxml) file is a set of markup languages designed for sub-application framework. Combined with basic components and event systems of the sub-application, the structure of the page of the sub-application can be built.

In this embodiment, a user can log in to a development application run on the terminal through a development application account, or a user can log in to a development application of a web version through a development application account. Next, the terminal displays a development project management page of the development application. When the user triggers a development project creation operation, the terminal responds to the development project creation operation and creates a sub-application development project. The user writes the page structure file in a development environment corresponding to the sub-application development project. The user refers to a developer.

In operation S204, the page structure file is parsed to obtain each predefined label in the page structure file, and convert each predefined label into an element in an extended reality interactive framework.

The predefined label is a label that is predefined. Each predefined label can have the same tag. Labels with predefined tags can be distinguished from other labels. For example, the predefined label is a label tagged with “XR-”.

In this embodiment, the predefined label can be a user-defined label.

The extended reality interactive framework, namely, extended reality (XR) interactive framework, is configured to build sub-applications of the extended reality interactive class.

XR, extended reality, is a new set of technical concepts. X represents both extended (Xtended) and an unknown variable (X), and R represents reality. XR is a collective term for augmented reality (AR), virtual reality (VR), and mixed reality (MR), three technologies. In addition, the three technologies are jointly applied to different scenes or industries. The virtual world and the real world are integrated in a variety of combinations, to achieve more possibilities for creation. For example, in the field of video, AR and MR technologies are used at the same time, through the detection of camera movements and lenses. The images of the virtual environment are filled to cover part of the real environment, which has the effect of supplementing and expanding the scene, that is, superimposing the virtual space in the real space. In this way, the limited space can be infinitely extended, so that the virtual image and the real image can be perfectly combined. XR, extended reality, technologies are a combination of the real space and the virtual space.

Virtual reality (VR) refers to a completely virtual personal experience.

Augmented reality (AR) refers to the superposition of virtual images on top of reality. Augmented reality (AR) is a technology that calculates a position and angle of a camera image in real time and adds the corresponding image, video, and 3D (three-dimensional) model. The technology can embed the virtual world into the real world on a screen and interact with the user.

Mixed reality (MR) refers to the virtual image that can actively interact based on reality, which can enhance the sense of reality of the user experience.

The extended reality interactive framework is an “entity-component-system” framework, including an entity, a component, and a system, and implements the sub-applications of the extended reality interactive class through the entity, the component, and the system. The sub-applications of the extended reality interactive class can be virtual reality sub-applications, augmented reality sub-applications, mixed reality sub-applications, etc., but are not limited to this.

The extended reality interactive framework can be a framework that includes an entity-component-system (ECS) architecture. The entity is an element.

The entity represents a base unit in the extended reality interactive framework. The entity can be identified by the extended reality interactive framework, and can also mount several components.

The component, that is, a component mounted to the entity, loads an attribute of a part of the entity. The attribute can be a pure data structure that does not contain functions.

The system refers to a whole with some functions formed by the interrelation and interaction of a number of parts. The system only focuses on entities with certain properties, that is, entities with certain components. The system is configured to process the attribute data.

Different systems have different functions. For example, a rendering system has the function of page rendering, and an animation system has the function of generating animated content.

Each basic unit in the extended reality interactive scene is an entity, and each entity is in turn composed of one or more components. Each of the components contains only data representing its properties, that is, there are no methods in the components. For example, MoveComponent, a component related to movement functions, contains attributes such as a speed, a position, an orientation, etc. An entity with MoveComponent means that the entity has the ability to move. The system is a tool for dealing with a collection of entities that have one or more of the same components. The system only owns the behavior, that is, there is no data in the system. In this example, the system that deals with movement only focuses on the entities that have the ability to move. It traverses all the entities that have the MoveComponent and updates the positions of the entities based on component configuration data related to the speed, the position, the orientation, etc. For example, the extend reality interactive scene is a game scene.

The entity and the component are in a one-to-many relationship. The capabilities of the entity depend on which components it has. By dynamically adding or deleting the components, the behavior of the entity can be changed when the extended reality interactive scene is run.

The entity plays a role of a “carrier” of the components in the ECS architecture, which is a collection of the components. The entity does not contain the data and business logic. In order to distinguish between different entities, it is generally represented by a data structure at the code level, such as using an identity (ID) to represent an entity. All components that make up the same entity are associated with the ID of the entity. In this way, it is clear that which components belong to the entity, making the associated component and the component configuration data to which the component is bound accessible through the entity.

Because the entity is a collection of the components, it is possible to dynamically add new components to the entity or remove the components from the entity at run time. For example, if a player in a game as an entity loses the ability to move due to reasons such as falling into a coma, simply remove a moving component from the entity to achieve the effect that the entity cannot move.

The component is bound to the component configuration data, however, the component itself cannot change the bound component configuration data, which is achieved through the system. The component configuration data bound to the component describes a feature of the entity, and the component needs to be loaded onto the entity in order for the component to be effective. What really contains the business logic is the system. An object of interest of the system is a collection of one or more components, through which the system captures entities with all the components in the collection. The system can also manipulate these entities, for example, delete the entities, add or remove the components from the entities, change the component configuration data to which the component is bound, and so on.

In this embodiment, the computer apparatus parses the page structure file and obtains each label in the page structure file. The labels can include the predefined labels and other labels except the predefined labels. The predefined labels can be converted into the extended reality interactive framework, while the remaining labels cannot be converted into the extended reality interactive framework.

The computer apparatus classifies the labels to filter out the predefined labels. The computer apparatus can obtain a preset extended reality interactive framework and convert each predefined label into an element in the extended reality interactive framework. A predefined label can be converted into an element in the extended reality interactive framework.

In this embodiment, the extended reality interactive framework has a pre-configured element library with a plurality of predefined labels and an element that matches each predefined label. After obtaining each predefined label in the page structure file, for each predefined label in the page structure file, the computer apparatus searches for the predefined label from the element library that is the same as the predefined label, and searches for the element matching the same predefined label from the element library. The found element is taken as an element in which the predefined tag is converted into the extended reality interactive framework. The found element is added to the extended reality interactive framework.

In operation S206, attribute information corresponding to each predefined label is obtained from the page structure file.

In operation S208, for each predefined label, the attribute information corresponding to the predefined label is converted into component information bound to the element converted from the predefined label.

The attribute information corresponding to the predefined label represents the attribute of the predefined label in the extended reality interactive page. A predefined label can correspond to one or more pieces of attribute information.

The component information represents the attribute of the element in the extended reality interactive framework. An element can correspond to one or more pieces of component information.

In this embodiment, for each predefined label, the computer apparatus obtains the attribute information corresponding to the predefined label from the page structure file. The computer apparatus determines the element in which the predefined label is converted into the extended reality interactive framework, and converts the attribute information corresponding to the predefined label into the component information bound to the element converted from the predefined label.

In this embodiment, the attribute information of the predefined label includes a label attribute corresponding to the predefined label and attribute data corresponding to the label attribute. The component information bound to the element includes the component associated with the element, and the component configuration data bound to the component.

In operation S208, the extended reality interactive page for the sub-application is generated based on each element in the extended reality interactive framework and the component information bound to each element, where the extended reality interactive page is configured for displaying interactions between a real scene and a virtual scene.

The virtual scene is a scene in which a virtual object performs activities or performs interactive actions when a virtual interactive application is run. The virtual scene can be a simulation environment of the real world, or it can be a semi-simulation semi-fictional virtual environment, or it can be a pure fictional virtual environment. For example, the virtual scene can be any of two-dimensional virtual scenes, 2.5-dimensional virtual scenes, and three-dimensional virtual scenes. The virtual scene can specifically be a mobile game scene, a terminal game scene, an interactive scene of a virtual object in augmented reality, virtual reality, or mixed reality, etc., but not limited to this. The user can control the movement of the virtual object in the virtual scene or perform the interactive actions.

The virtual object is an object that can be rendered in the virtual scene and can be an object that can move. The virtual object is not limited to a virtual person, a virtual animal, a virtual plant, a virtual environment, or the like. For example, the virtual object can be a person, an animal, a plant, or the like displayed in the virtual scene. The virtual scene can contain a plurality of virtual objects. Each virtual object has its own form and volume in the virtual scene and can occupy a part of the space in the virtual scene.

In this embodiment, the computer apparatus generates the extended reality interactive page based on each element in the extended reality interactive framework and the component information bound to each element, to obtain the sub-application. The sub-application can display the page content of the extended reality interactive page. The sub-application belongs to a sub-application of the extended reality interactive class. The user can run the sub-application in a parent application, and enable the interactions between the real scene and the virtual scene in the extended reality interactive page for the sub-application.

The foregoing sub-application processing method, device, computer apparatus, computer-readable storage medium and computer program product obtains the page structure file corresponding to the sub-application. The obtained page structure file is configured for describing the structure of the extended reality interactive page to be generated for the sub-application, so that a page layout of the extended reality interactive page to be generated can be known through the page structure file. The page structure file is parsed to obtain each predefined label in the page structure file. The obtained predefined label is predefined by the user and can be converted into a specific label used in the extended reality interactive framework. In this way, each predefined label can be converted into an element in the extended reality interactive framework. Obtain attribute information corresponding to each predefined label from the page structure file. For each predefined label, convert the attribute information corresponding to the predefined label into component information bound to the element converted from the predefined label. In this way, both the predefined label and the corresponding attribute information in the page structure file can be converted into the element and the component information in the extended reality interactive framework. In addition, the corresponding relationship between each element and each piece of component information in the extended reality interactive framework follows the corresponding relationship between the predefined label and the attribute information in the page structure file. Based on each element in the extended reality interactive framework and the component information bound to each element, the extended reality interactive page for the sub-application is generated. In this way, the creation of the sub-application of the extended reality interactive class can be enabled through the extended reality interactive framework itself, without the need to introduce a third-party tool for processing. As a result, the development of the sub-application of the extended reality interactive class is made easier. It effectively lowers a threshold for developers to get started with the development of the sub-application of the extended reality interactive class. In addition, the extended reality interactive page can provide the interactions between the real scene and the virtual scene. In this way, the sub-application can bring a human-machine interactive environment combining the real scene and the virtual scene to the user.

In one embodiment, the user can generate custom elements and components in the extended reality interactive framework and generate predefined labels that match each element. When generating the sub-application, the predefined label matching the custom element is used to generate the page structure file, so that the computer apparatus can automatically convert the predefined label in the page structure file into the matched element in the extended reality interactive framework.

In this embodiment, the user can generate custom elements and components in the extended reality interactive framework and generate predefined labels that match each element, as well as a label attribute matching each component. When generating the sub-application, the predefined label matching the custom element and the label attribute matching the component are used to generate the page structure file, so that the computer apparatus can automatically convert the predefined label in the page structure file into the matched element in the extended reality interactive framework, and convert the label attribute into the matched component in the extended reality interactive framework.

In this embodiment, the extended reality interactive framework provides the user with the generation function of elements and components, so that the user can customize the generation of required elements and components. In this way, the flexibility and extensibility of the extended reality interactive framework is improved.

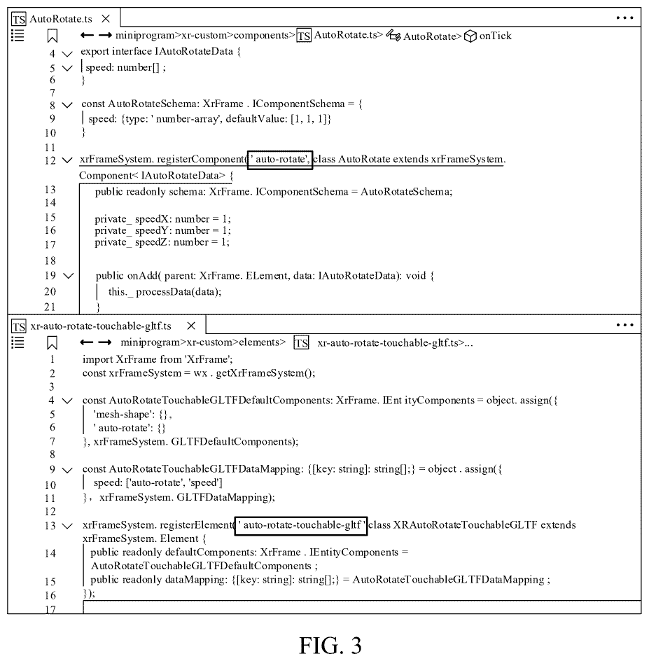

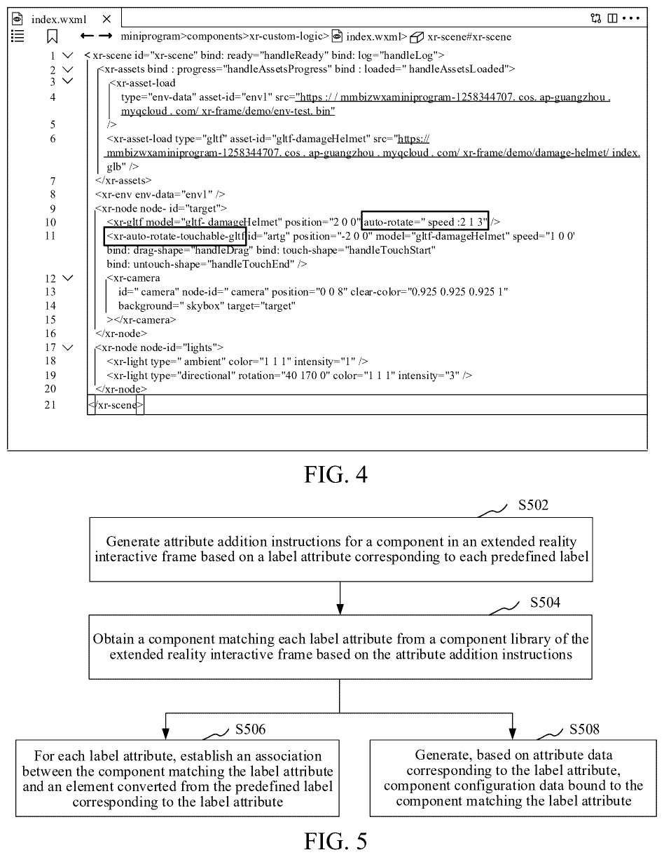

In one embodiment, the sub-application processing method not only lowers the threshold for the sub-application development, but also improves the flexibility and extensibility of the sub-application. The developers only need to use an interface like “registerComponent” to define the components and elements on their own, which is equivalent to customizing the labels and attributes in “wxml”. As shown in FIG. 3, FIG. 3 shows codes used to customize the components. Through a registration mechanism of XR-FRAME, the developers have registered the “auto-rotate” component, which can be used as an attribute in the “wxml” to make a 3D node corresponding to the mounted element automatically rotate each frame. “Auto-rotation-touchable gltf” shows how the functionality of multiple components can be pre-combined into a single element that integrates auto-rotation, interactivity, and GlTF rendering capabilities for subsequent use. As shown in FIG. 4, FIG. 4 shows codes for calling a custom component during the process of generating a sub-application.

In one embodiment, attribute information corresponding to a predefined label includes a label attribute corresponding to the predefined label, and attribute data corresponding to the label attribute; and component information bound to each element, including a component associated with each element, and component configuration data bound to the component.

The for each predefined label, converting the attribute information corresponding to the predefined label into component information bound to the element converted from the predefined label includes:

For each predefined label, the component associated with the element converted from the predefined label is generated based on the label attribute corresponding to the predefined label. For each label attribute, based on the attribute data corresponding to the label attribute, the component configuration data bound to the component matching the label attribute is generated in the extended reality interactive framework.

A component is associated with an element, indicating that the component belongs to the element. For example, a component a is associated with an element A, indicating that the component a belongs to the element A. A component can belong to at least one element.

In this embodiment, the computer apparatus converts each predefined label into an element in the extended reality interactive framework, and a predefined label in the page structure file can correspond to one or more label attributes.

The computer apparatus can obtain each label attribute corresponding to the predefined label from the page structure file. Based on each label attribute, the computer apparatus generates each component associated with the element converted from the predefined label in the extended reality interactive framework. A label attribute can generate a component.

For the attribute data corresponding to each label attribute, the computer apparatus generates the component configuration data bound to the component matching the label attribute in the extended reality interactive framework based on the attribute data corresponding to the label attribute.

In this embodiment, each predefined label in the page structure file is converted into an element in the extended reality interactive framework, the label attribute corresponding to the predefined label is converted into a component associated with the element, and the attribute data corresponding to the label attribute is converted into the component configuration data bound to the component. In this way, various parts of the structure describing the extended reality interactive page can be converted into the extended reality interactive framework, and subsequently the extended reality interactive page can be directly generated by using the elements, components and component configuration data through the extended reality interactive framework. As a result, the development of the sub-application of the extended reality interactive class can be realized without additional processing by the third-party tool. It lowers the development threshold for the sub-application of the extended reality interactive class.

In one embodiment, as shown in FIG. 5, the for each predefined label, converting the attribute information corresponding to the predefined label into component information bound to the element converted from the predefined label includes:

In operation S502, attribute addition instructions for a component in the extended reality interactive framework are generated based on the label attribute corresponding to each predefined label.

The attribute addition instructions are instructions used to configure attributes for components in the extended reality interactive framework. The attributes in the extended reality interactive framework are characterized by the components. The attributes of the components in the extended reality interactive framework are characterized by the component configuration data.

In this embodiment, the computer apparatus may generate attribute addition instructions based on each predefined label and the label attribute corresponding to the predefined label. The attribute addition instructions indicate the addition of the component configuration data for the components in the extended reality interactive framework.

In this embodiment, the computer apparatus transmits the attribute addition instructions to a template engine. The attribute addition instructions are configured for instructing the template engine to convert each label attribute into a component in the extended reality interactive framework. The template engine is an engine tool that can combine the page structure and the data to be displayed to generate the extended reality interactive page. The template engine can be run on a server side or on a client side, and can be parsed directly into markup languages on the server side, and then passed to the client side after completion.

In operation S504, a component matching each label attribute from a component library of the extended reality interactive framework is obtained based on the attribute addition instructions.

In this implementation, multiple components are stored in the component library of the extended reality interactive framework. The component in the component library can be a user-defined generated component, or a generic component in the extended reality interactive framework.

The computer apparatus matches each label attribute with each component in the component library of the extended reality interactive framework based on the attribute addition instructions, to get a component that matches each label attribute.

In operation S506, for each label attribute, an association is established between the component matching the label attribute and the element converted from the predefined label corresponding to the label attribute.

In this embodiment, for each label attribute, the computer apparatus determines the component matching the label attribute, determines the element converted from the predefined label corresponding to the label attribute, and associates the determined component with the element, to obtain the component information bound to the element converted from each predefined label.

In operation S508, the component configuration data bound to the component matching the label attribute is generated based on the attribute data corresponding to the label attribute.

For each label attribute, the computer apparatus determines the attribute data corresponding to the label attribute and determines the component that matches the label attribute. The computer apparatus takes the determined attribute data as the component configuration data of the determined component, and binds the determined component and the component configuration data of the determined component.

In this embodiment, the page structure file corresponding to the sub-application is obtained through the template engine, and the page structure file is parsed to obtain each predefined label in the page structure file and the label attribute corresponding to each predefined label. Based on the label attribute corresponding to each predefined label, the attribute addition instructions are generated through the template engine. The attribute addition instructions are sent to a back end of the extended reality interactive framework, to instruct the back end of the extended reality interactive framework to find the component matching each label attribute and associate the found component with the corresponding element.

In this embodiment, based on the label attribute corresponding to each predefined label, the attribute addition instructions for the component in the extended reality interactive framework are generated, to obtain the component matching each label attribute from the component library of the extended reality interactive framework based on the attribute addition instructions. In this way, the label attribute in the page structure file can be converted into the corresponding component in the extended reality interactive framework. For each label attribute, the component matching the label attribute is associated with the element converted from the predefined label corresponding to the label attribute, so that the corresponding relationship between the component and the element is consistent with the corresponding relationship between the predefined label and the label attribute, to ensure the accuracy of the converted data. In addition, based on the attribute data corresponding to the label attribute, the component configuration data bound to the component matching the label attribute is generated. The attribute data corresponding to the label attribute can be migrated to the component in the extended reality interactive framework. In this way, the binding relationship between the component and the component configuration data is consistent with the corresponding relationship between the label attribute and the attribute data, to ensure the accuracy of the converted data.

In one embodiment, the extended reality interactive framework includes a plurality of systems, each of the systems corresponds to at least one component, and each of the systems is configured to process component configuration data of the corresponding component.

The generating the extended reality interactive page for the sub-application based on each element in the extended reality interactive framework and the component information bound to each element includes:
determining a system corresponding to each component in the extended reality interactive framework; for each component, transmitting the component configuration data bound to the component to the system corresponding to the component; and driving each system to perform processing of the received component configuration data to form corresponding page content, to obtain the extended reality interactive page for the sub-application.

In this embodiment, the extended reality interactive framework includes a plurality of systems, and each of the systems is configured to process component configuration data of the corresponding component. For example, the rendering system is configured to process component configuration data related to rendering, the animation system is configured to process component configuration data related to animation content, and an AR system is configured to process component configuration data related to AR.

After each element, the label attribute, and the attribute information in the page structure file are converted into the corresponding element, the component, and the component configuration data, a system corresponding to each component is determined. A system may correspond to one or more components.

For each component, the computer apparatus transmits the component configuration data bound to the component to the system corresponding to the component, and drives each system to perform processing of the received component configuration data to form corresponding page content. The content of each page forms the extended reality interactive page for the sub-application, to obtain the sub-application of the extended reality interactive class.

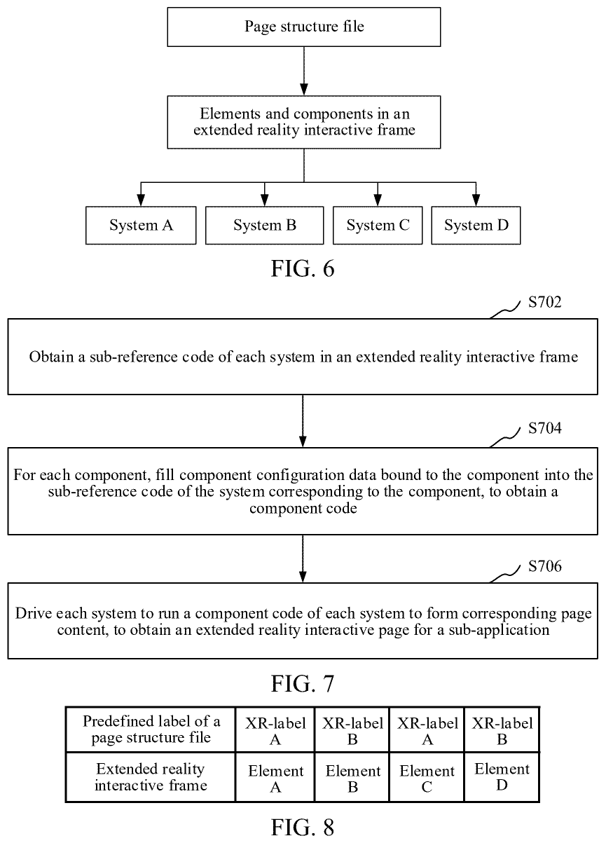

For example, as shown in FIG. 6, the extended reality interactive framework includes systems A, B, C, and D. After converting each predefined label, the label attribute corresponding to the predefined label, and the attribute data corresponding to the label attribute in the page structure file into each element, the component associated with the element, and the component configuration data bound to the component in the extended reality interactive framework, a component a corresponding to the system A is determined. Component configuration data of the component a is sent to the system A. A component b corresponding to the system B is determined. Component configuration data of the component b is sent to the system B. A component c corresponding to the system C is determined. Component configuration data of the component c is sent to the system C. A component d corresponding to the system D is determined. Component configuration data of the component d is sent to the system D.

In this embodiment, the system focuses on the corresponding component configuration data, rather than the component configuration data bound to all the components corresponding to an element. For example, in a game sub-application, there are a plurality of objects. Each object has a corresponding skill, and each skill is configured with corresponding skill data. There is a skill system, a mobile system and the like in the extended reality interactive framework. However, the skill system only focuses on and processes the skill data of each object, and the mobile system only focuses on and processes the displacement data of each object.

In this embodiment, the extended reality interactive framework integrates a plurality of systems, and each of the systems corresponds to at least one component. In this way, each of the systems can process component configuration data of the corresponding component. After converting each predefined label, the label attribute corresponding to the predefined label, and the attribute data corresponding to the label attribute in the page structure file into each element, the component associated with the element, and the component configuration data bound to the component in the extended reality interactive framework, the system corresponding to each component in the extended reality interactive framework is determined, to accurately determine which component data needs to be sent to which system for processing. As a result, for each component, the component configuration data bound to the component is sent to the system corresponding to the component. Drive each of the systems to perform processing of received component configuration data, so that corresponding page content can be formed through the processing of the corresponding component configuration data by each system. In this way, a subroutine of the extended reality interactive class can be built directly in the extended reality interactive framework without using external tools. The cost of developing the subroutine of the extended reality interactive class is reduced, and the efficiency of the subroutine of the extended reality interactive class is improved.

In one embodiment, as shown in FIG. 7, the driving each of the systems to perform processing of the received component configuration data to form corresponding page content, to obtain the extended reality interactive page for the sub-application includes:

In operation S702, a sub-reference code of each of the systems in the extended reality interactive framework is obtained.

In operation S704, for each component, the component configuration data bound to the component is filled into the sub-reference code of the system corresponding to the component, to obtain a component code.

The sub-reference code is a code that drives the system to run, to implement the corresponding function in the sub-application.

In this embodiment, the computer apparatus obtains a sub-reference code of each of the systems in the extended reality interactive framework. For each component, adjust the sub-reference code of the system corresponding to the component based on the component configuration data bound to the component, to obtain the component code.

In this embodiment, for each component, the computer apparatus fills the component configuration data bound to the component into the sub-reference code of the system corresponding to the component, to obtain the component code corresponding to the component.

In operation S706, each of the systems is driven to run a component code of each of the systems to form the corresponding page content, to obtain the extended reality interactive page for the sub-application.

Specifically, the computer apparatus drives each of the systems to run a component code of each of the systems to form the corresponding page content. The content of each page forms the extended reality interactive page, to obtain the sub-application of the extended reality interactive class.

In this embodiment, there is a corresponding reference framework code in the extended reality interactive framework, the extended reality interactive framework includes a plurality of systems, and the reference framework code includes a sub-reference code corresponding to each of the systems.

In this embodiment, the sub-reference code of each of the systems in the extended reality interactive framework is obtained, and each piece of component configuration data is filled into the sub-reference code of the corresponding system. In this way, the component code can be automatically generated without the need for the user to write the code. Each of the systems is driven to run a component code of each of the systems to form the corresponding page content, to obtain the extended reality interactive page for the sub-application. In this way, a user-defined sub-application of the extended reality interactive class can be built, which can shorten the development cycle and improve the development efficiency. Moreover, through the addition of elements and components, as well as the binding of component configuration data, the user who knows little about the development of the sub-application of the extended reality interactive class can also realize the development of various parts and functions of the sub-application, making the development of the sub-application of the extended reality interactive class easier.

In one embodiment, the plurality of systems include at least a rendering system, and each of the components includes at least a component corresponding to the rendering system.

The for each component, transmitting the component configuration data bound to the component to the system corresponding to the component includes: obtaining page rendering data from the component configuration data bound to the component corresponding to the rendering system; and transmitting the page rendering data to the rendering system.

The driving each system to perform the received component configuration data and form corresponding page content, to obtain the extended reality interactive page for the sub-application includes: controlling the rendering system to perform page rendering based on the page rendering data and form the corresponding page content, to obtain the extended reality interactive page for the sub-application.

The page rendering is a process of completing a page layout and drawing based on a certain rule for page resources returned by a request. For example, the page resources are texts, images, animations, videos, audios, etc., but are not limited to this.

The plurality of systems in the extended reality interactive framework include a rendering system, and each of the components includes at least a component corresponding to the rendering system.

In this embodiment, the computer apparatus determines a system corresponding to each component in the extended reality interactive framework. When the plurality of systems include a rendering system, and each of the components of the extended reality interactive framework includes a component corresponding to the rendering system, page rendering data is obtained from component configuration data bound to the component. The computer apparatus transmits the page rendering data to the rendering system.

The computer apparatus controls the rendering system to perform page rendering based on the page rendering data to form the corresponding page content, to obtain the extended reality interactive page for the sub-application.

In this embodiment, each of the components includes at least a component corresponding to the rendering system. Component configuration data bound to the component corresponding to the rendering system includes page rendering data. The computer apparatus transmits the page rendering data bound to the component corresponding to the rendering system to the rendering system.

In this embodiment, the page rendering can be real-time page rendering. The real-time page rendering refers to the drawing of three-dimensional data into a two-dimensional bitmap based on a graphical algorithm, and the display of these bitmaps in real time. Its essence is the real-time calculation and output of image data, which requires rendering the image and displaying it in a short time, and rendering and displaying the next image at the same time.

In this embodiment, the rendering system is integrated in the extended reality interactive framework to obtain page rendering data from the component configuration data bound to the component corresponding to the rendering system in the extended reality interactive framework, and transmit the page rendering data to the rendering system in the extended reality interactive framework. In this way, the rendering system uses the page rendering data for page rendering, to form the corresponding page content. As such, when developing the sub-application of the extended reality interactive class, it is not necessary to rely on third-party rendering engines, but can quickly realize the page rendering directly by the rendering system of the extended reality interactive framework, which is convenient for the developers who do not know the relevant knowledge of the third-party rendering engines to realize the development of the sub-application of the extended reality interactive class. This lowers the threshold for developing the sub-application of the extended reality interactive class.

In one embodiment, the plurality of systems further include an animation system, and the components further include a component corresponding to the animation system. The method further includes:
obtaining animation data from component configuration data bound to the component corresponding to the animation system, and transmitting the animation data to the animation system.

The controlling the rendering system to perform page rendering based on the page rendering data to form the corresponding page content, to obtain the extended reality interactive page for the sub-application includes:
controlling the rendering system to perform the page rendering based on the page rendering data, and controlling the animation system to generate animation content based on the animation data to form the page content including the animation content, to obtain the extended reality interactive page for the sub-application.

The animation data is data configured for generating the animation content in the extended reality interactive page, such as dynamic people, dynamic objects, etc.

The plurality of systems in the extended reality interactive framework further include an animation system, and each of the components further includes a component corresponding to the animation system.

In this embodiment, the computer apparatus determines a system corresponding to each component in the extended reality interactive framework. When the plurality of systems include an animation system, and each of the components includes a component corresponding to the animation system, animation data is obtained from component configuration data bound to the component corresponding to the animation system, and the animation data is sent to the animation system.

The computer apparatus controls the rendering system to perform page rendering based on the page rendering data, and controls the animation system to generate animation content based on the animation data, to obtain static page content and dynamic page content. The dynamic page content is the animation content. The static page content and the dynamic page content form the extended reality interactive page for the sub-application, to obtain the sub-application of the extended reality interactive class.

In this embodiment, each of the components includes at least a component corresponding to the animation system. Component configuration data bound to the component corresponding to the animation system includes animation data. The computer apparatus transmits the animation data bound to the component corresponding to the animation system to the animation system.

In this embodiment, the animation system is also integrated in the extended reality interactive framework, and each of the components also includes a component corresponding to the animation system. Animation data is obtained from component configuration data bound to the component corresponding to the animation system, and the animation data is sent to the animation system. The rendering system is controlled to perform page rendering based on the page rendering data, and the animation system is controlled to generate the animation content based on the animation data to generate the dynamic page content and the static page content. In this way, when developing the sub-application of the extended reality interactive class, it is not necessary to rely on third-party related engines, but can quickly realize the page rendering and animation generation directly by the rendering system and the animation system in the extended reality interactive framework. This makes it possible for the developers to develop the sub-application of the extended reality interactive class without the relevant knowledge of the third-party related engines, thus lowering the threshold for developing the sub-application of the extended reality interactive class and making the development of the sub-application of the extended reality interactive class easier.

In one embodiment, the converting each predefined label into an element in the extended reality interactive framework includes:
generating element creation instructions for the extended reality interactive framework based on each predefined label; and based on the element creation instructions, obtaining an element matching each predefined label from an element library of the extended reality interactive framework, and adding the element matching each predefined label to the extended reality interactive framework.

The element creation instructions are instructions that convert the predefined labels in the page structure file into the elements in the extended reality interactive framework. A plurality of elements are stored in the element library. The elements in the element library can be user-defined generated elements or common elements in the extended reality interactive framework.

In this embodiment, the computer apparatus generates the element creation instructions for the extended reality interactive framework based on each predefined label. The computer apparatus determines the element library preset by the extended reality interactive framework, and based on the element creation instructions, matches each predefined label with each element in the element library, obtains the element matching each predefined label, and then adds the obtained element to the extended reality interactive framework. As shown in FIG. 8, if the predefined labels in the page structure file are respectively XR-label A, XR-label B, XR-label C, and XR-label D, they are converted into an element A, an element B, an element C, and an element D in the extended reality interactive framework, respectively.

In this embodiment, based on each predefined label, generate the element creation instructions for the extended reality interactive framework, to obtain the element matching each predefined label from the element library of the extended reality interactive framework based on the element creation instructions. As such, add the obtained element to the extended reality interactive framework, realizing the accurate conversion of the predefined labels in the page structure file and the elements in the extended reality interactive framework. In this way, generate the extended reality interactive page based on the element possessed in the extended reality interactive framework.

In one embodiment, the generating the extended reality interactive page for the sub-application based on the element in the extended reality interactive framework and the component information bound to the element includes:
obtaining a reference framework code corresponding to the extended reality interactive framework; and based on the element in the extended reality interactive framework, and the component information bound to the element, adjusting the reference frame code to obtain a page framework code of the sub-application, the page framework code of the sub-application being configured for generating the extended reality interactive page for the sub-application based on the extended reality interface framework.

In this embodiment, the extended reality interactive framework has a pre-configured framework code that is referred to as the reference framework code. The reference framework code is configured for creating the sub-application based on the structure of the extended reality interactive framework. The computer apparatus adjusts the corresponding reference element and component information in the reference framework code based on the element in the extended reality interactive framework and the component information bound to the element, to obtain the page framework code of the sub-application. The computer apparatus can generate the extended reality interactive page by running the page framework code, to obtain the sub-application.

In this embodiment, the computer apparatus fills to the corresponding position in the reference framework code based on the element in the extended reality interactive framework and the component information bound to the element, to obtain the page framework code of the sub-application.

In this embodiment, the computer apparatus may obtain a page style file. The page style file is configured for describing at least one of local or global styles of the extended reality interactive page for the sub-application. The computer apparatus can generate the extended reality interactive page for the sub-application based on the page style file and the page framework code of the sub-application.

In this embodiment, the extended reality interactive framework has the corresponding reference framework code. The extended reality interactive framework includes a plurality of systems. The reference framework code includes a sub-reference code corresponding to each system. The adjusting the reference framework code to obtain a page framework code of the sub-application based on the element in extended reality interactive framework and the component information bound to the element includes:
for each component, filling the component configuration data bound to the component into the sub-reference code of the system corresponding to the component, to obtain a component code; and driving each of the systems to run a component code of each of the systems to form the corresponding page content, to obtain the extended reality interactive page for the sub-application.

In this embodiment, obtain a reference framework code corresponding to the extended reality interactive framework. Based on the element in the extended reality interactive framework, and the component information bound to the element, adjust the reference framework code to obtain a page framework code of the sub-application. In this way, a user-defined sub-application of the extended reality interactive class can be generated automatically without the need for the user to write the code, which can shorten the development cycle and improve the development efficiency. Moreover, through the addition of elements and components, as well as the binding of component configuration data, the user who does not know how to code can also develop the sub-application on his or her own, making the development of the sub-application easier.

In one embodiment, the method further includes:
calling a camera in the extended reality interactive page to capture a real scene through the camera; obtaining pre-stored three-dimensional model material, and generating a three-dimensional virtual object based on the three-dimensional model material; and synthesizing the real scene with the three-dimensional virtual object, and displaying an enhanced scene image obtained through synthesis in the extended reality interactive page.

In this embodiment, after the sub-application of the extended reality interactive class is generated, the sub-application is run in the parent application.

The parent application provides a running environment for the running of the sub-application. After the sub-application is generated, the user can trigger a parent application identifier. The terminal switches to the parent application and runs the sub-application in the running environment provided by the parent application in response to the trigger operation of the parent application.

The extended reality interactive page is displayed in the sub-application. The extended reality interactive page provides a calling interface for the camera of the terminal. The user can call the camera in the extended reality interactive page through the calling interface, and capture the real scene through the camera.

The three-dimensional model material is pre-stored in the computer apparatus, and the three-dimensional model material is configured to generate corresponding three-dimensional virtual object. The three-dimensional virtual object can be a virtual person or object in the three-dimensional space. The computer apparatus generates the corresponding three-dimensional virtual object through the three-dimensional model material.

The computer apparatus synthesizes the real scene with the three-dimensional virtual object, to obtain the enhanced scene image. The computer apparatus outputs the enhanced scene image to the extended reality interactive page for the sub-application, to display the enhanced scene image in the extended reality interactive page.

In this embodiment, a calling function of a camera is provided in the extended reality interactive page. In this way, the user can capture a real scene through the camera. Obtain pre-stored three-dimensional model material, generate a three-dimensional virtual object based on the three-dimensional model material, synthesize the real scene with the three-dimensional virtual object to obtain an enhanced scene image, and realize the combination of the real scene and the virtual object through the extended reality interactive page. By displaying the enhanced scene image in the sub-application, the scene image combined the reality with the virtuality can be presented through the sub-application. In this way, the user is provided with a function of combining the reality with the virtuality through the sub-application of the extended reality interactive class, expanding the interactive capability of the sub-application.

In one embodiment, the synthesizing the real scene with the virtual object, and displaying an enhanced scene image obtained through synthesis in the extended reality interactive page includes:
obtaining pose information of the camera, and generating a simulation scene that simulates the real scene based on the pose information of the camera; and integrating the three-dimensional virtual object into the simulation scene, to obtain the enhanced scene image displayed in the extended reality interactive page.

In this embodiment, the computer apparatus obtains the pose information of the camera. The pose information represents three-dimensional spatial data of the camera. The computer apparatus generates the simulation scene that simulates the real scene based on the pose information of the camera. The virtual scene is a simulation scene of the real scene. The computer apparatus integrates the generated three-dimensional virtual object into the simulation scene, to obtain the enhanced scene image including the simulation scene and the three-dimensional virtual scene. The enhanced scene image is displayed in the extended reality interactive page for the sub-application.

In this embodiment, the pose information of the camera is obtained. A virtual scene matching the real scene is generated based on the pose information of the camera, to integrate the three-dimensional virtual scene into the virtual scene and obtain the enhanced scene image displayed in the extended reality interactive page. In this way, virtual content can be superimposed on the real scene captured by the camera in real time and the virtual content can be seamlessly combined with the real scene. This adds visual effects to virtual reality interactions.

In this embodiment, a sub-application processing method, applied to a computer apparatus is provided, where the method includes:
obtaining a page structure file corresponding to a sub-application, where the page structure file is configured for describing a structure of an extended reality interactive page to be generated for the sub-application.

The page structure file is parsed to obtain each predefined label in the page structure file; and element creation instructions for the extended reality interactive framework are generated based on each predefined label.

Based on the element creation instructions, obtain an element matching each predefined label from an element library of the extended reality interactive framework.

Obtain a label attribute corresponding to each predefined label and attribute data corresponding to each label attribute from the page structure file.

Based on the label attribute corresponding to each predefined label, attribute addition instructions for the component in the extended reality interactive framework are generated. The component matching each label attribute is obtained from the component library of the extended reality interactive framework based on the attribute addition instructions. For each label attribute, the component matching the label attribute is associated with the element converted from the predefined label corresponding to the label attribute. The component configuration data bound to the component matching the label attribute is generated in the extended reality interactive framework based on the attribute data corresponding to the label attribute.

The system corresponding to each component is determined in the extended reality interactive framework.

For each component, the component configuration data bound to the component is sent to the system corresponding to the component.

Obtain a sub-reference code of each of the systems in the extended reality interactive framework. For each component, the component configuration data bound to the component is filled into the sub-reference code of the system corresponding to the component, to obtain the component code. Drive each of the systems to run a component code of each of the systems to form the corresponding page content, to obtain the extended reality interactive page for the sub-application. The sub-application is run on the parent application.

Further, when the plurality of systems include a rendering system and an animation system, and each of the components includes a component corresponding to the rendering system and a component corresponding to the animation system. Page rendering data is obtained from component configuration data bound to the component, and the page rendering data is sent to the rendering system. Animation data is obtained from component configuration data bound to the component corresponding to the animation system, and the animation data is sent to the animation system. The rendering system is controlled to perform page rendering based on the page rendering data, and the animation system is controlled to generate animation content based on the animation data, to form the extended reality interactive page for the sub-application, and obtain the sub-application of the extended reality interactive class.

After the sub-application is generated, call a camera in the extended reality interactive page to capture a real scene through the camera; obtain pre-stored three-dimensional model material, and generate a three-dimensional virtual object based on the three-dimensional model material; and synthesize the real scene with the three-dimensional virtual object, and display an enhanced scene image obtained through synthesis in the extended reality interactive page.

In this embodiment, by obtaining the page structure file corresponding to the sub-application, and the page structure file is configured for describing the structure of the extended reality interactive page to be generated, the page layout of the sub-application page to be generated can be known through the page structure file. The page structure file is parsed to obtain each predefined label in the page structure file. The obtained predefined label is a label that is predefined. The label can be converted into an element in the extended reality interactive framework. Each predefined label is converted into an element in the extended reality interactive framework, the label attribute corresponding to the predefined label is converted into a component associated with the element, and the attribute data corresponding to the label attribute is converted into the component configuration data bound to the component. In this way, various parts of the structure describing the extended reality interactive page can be converted into the extended reality interactive framework, so that the extended reality interactive page can be directly generated by using the elements, components and component configuration data through the extended reality interactive framework subsequently.

The extended reality interactive framework includes a plurality of systems, and each of the systems corresponds to at least one component. In this way, each of the systems can process component configuration data of the corresponding component. After converting each predefined label, the label attribute corresponding to the predefined label, and the attribute data corresponding to the label attribute in the page structure file into each element, the component associated with the element, and the component configuration data bound to the component in the extended reality interactive framework, the system corresponding to each component in the extended reality interactive framework is determined, to accurately determine which components need to be sent to which system for processing. As a result, for each component, the component configuration data bound to the component is sent to the system corresponding to the component. Drive each of the systems to perform processing of received component configuration data, so that corresponding page content can be formed through the processing of the corresponding component configuration data by each system. In this way, a subroutine of the extended reality interactive class can be built directly in the extended reality interactive framework without using external tools. The developing threshold and developing cost of the subroutine of the extended reality interactive class are reduced, and the efficiency of the subroutine of the extended reality interactive class is improved.

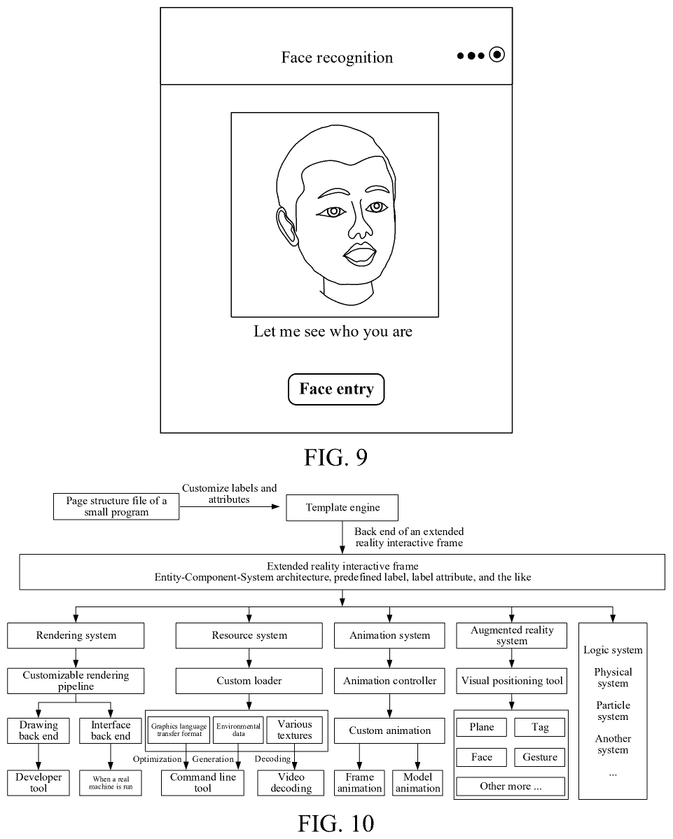

The sub-application generation method is applicable to the sub-application generation of any extended reality interactive class, such as a big data class sub-application, an artificial intelligence class sub-application, an Internet of Things class sub-application. The sub-application generation method is applicable to a mobile side and a web side. The user can develop the sub-application on the mobile side or the web side. As shown in FIG. 9, the extended reality interactive page is generated by the user through the sub-application generation method. The extended reality interactive page can be used for face recognition.

In one embodiment, an application scene of a sub-application processing method is provided, which is specifically applied to a development scene of a sub-application of an extended reality interactive class. The sub-application of the extended reality interactive class is an XR small program, and the extended reality interactive framework includes an ECS framework. As shown in FIG. 10, in this embodiment, the development of the XR small program is divided into three parts. The first part is to parse the page structure file of the small program into structured data and instructions, and the page structure file is wxml. The second part is to convert the structured data into elements and components of the extended reality interactive framework, the ECS framework is a framework that includes ECS, and the elements are entities in the ECS framework. The third part is that the logic is driven by each system and finally renders the logic. A specific process is as follows.

The first part is an upper part of the architecture diagram. A special type of native labels of small programs, namely, predefined labels, are customized in advance in the extended reality interactive framework, and may start with “xr-”. In a parsing process, the template engine first obtains code segments in the page structure file wxml, analyzes and classifies labels in the wxml file, to separate labels starting from “xr-” from other common user interface (UI) labels.

Calling instructions, namely, element creation instructions, similar to “createElement” are generated based on each predefined label. The label attribute corresponding to each predefined label in the wxml file is determined. The calling instructions, namely, attribute addition instructions, similar to “addAttribute” are generated based on the label attribute corresponding to each predefined label. The template engine forwards the element creation instructions and the attribute addition instructions to an “xr-frame” back end of the ECS framework. The extended reality interactive framework is specifically implemented for the template engine. After receiving these instructions, the “xr-frame” back end automatically creates an element corresponding to the predefined label and a component matching the label attribute in the ECS framework. The small program label corresponds to an element in the ECS, and the small program attribute corresponds to a component in the ECS.

The second part is a middle part of the architecture diagram. In the “xr-frame” back end, the developer may register an element and a component by using methods such as “registerElement” and “registerComponent”, to self-define the component and the element in the ECS framework. After receiving the element creation instructions and the attribute addition instructions, the “xr-frame” back end finds elements and components indicated by template engine instructions by using a look-up table method. For example, a predefined label “xr-Camera”corresponds to a “Camera” element. After these elements and components are found, the ECS framework further parses attribute data transmitted from the template engine. The attribute data may be of a character string type. A data parser converts the attribute data into the corresponding data such as “number” and “array” in the ECS framework based on types of the attribute data, to obtain component configuration data corresponding to each component. Further, life cycles such as “onAdd” and “onUpdate” of the component are triggered to update the component configuration data, and are bound to the component. After the component is ready, the component is handed over to the following systems for processing.

The third part is a lower part of the architecture diagram. Each system in the ECS framework receives the component configuration data generated in the second operation, and drives an entire logical cycle. The ECS framework mainly uses a callback per frame to drive all systems mounted to the scene. The rendering system includes a programmable rendering pipeline, and the developer determines how to delete a scene, assemble a rendering queue, and render the rendering queue. A resource system is responsible for managing loading of all resources, the animation system drives all the frame animation and the model animation in the scene, and the AR system drives camera image rendering of a visual positioning tool (VisionKit), automatic matching of recognition points, and the like. A logical system, a physical system, a particle system, and the like are also included, and other systems are further included.

The rendering system includes a Web Graphics Library (WebGL), and WebGL is a 3D drawing protocol.

The resource system includes a user-defined loader, and the developer may self-define loading of a Graphics Language Transmission Format (GLTF), environment data (EnvData), and various textures. The resource system provides a command line tool xr-frame-cli, and the command line tool xr-frame-cli integrates two functions, namely, environment data generation and glTF optimization.

In addition, each system has a code. After receiving component configuration data of a corresponding component, each system fills the code with the component configuration data of the corresponding component and runs the code, then performs calculation processing, and updates a calculation result to the component, so that an entity has a specific function and can perform a specific operation.

According to the sub-application processing method of this embodiment, costs of developing a 3D application and an XR application in a small program by the developer are greatly reduced, and better experiences are brought to the developer.

In this embodiment, main operations in which the developer develops a 3D small program and an XR small program through the sub-application processing method are as follows.

A small program component is created, and a third-party renderer “renderer” is set to “xr-frame” in a “json” configuration.

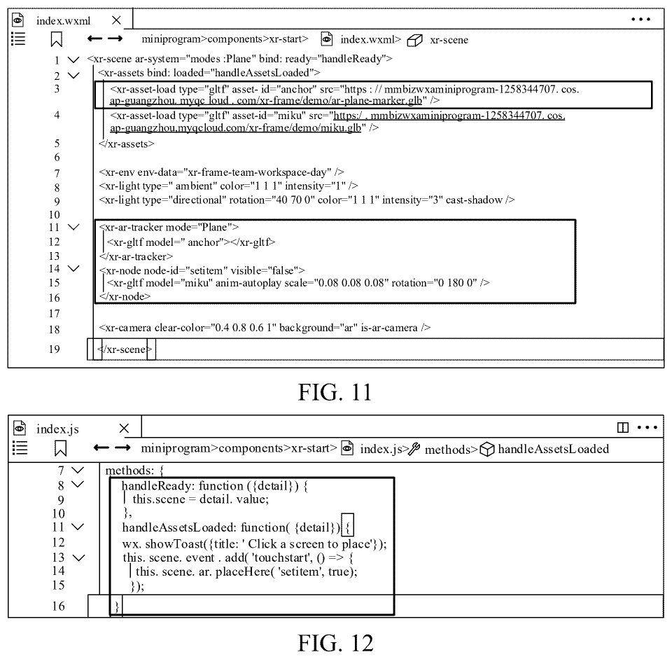

As shown in FIG. 11, a page structure file wxml is opened. Like a common small program component, a code is written by using a markup language. Some javascript codes may alternatively be written based on requirements, as shown in FIG. 12.

Debugging is run on a real machine.

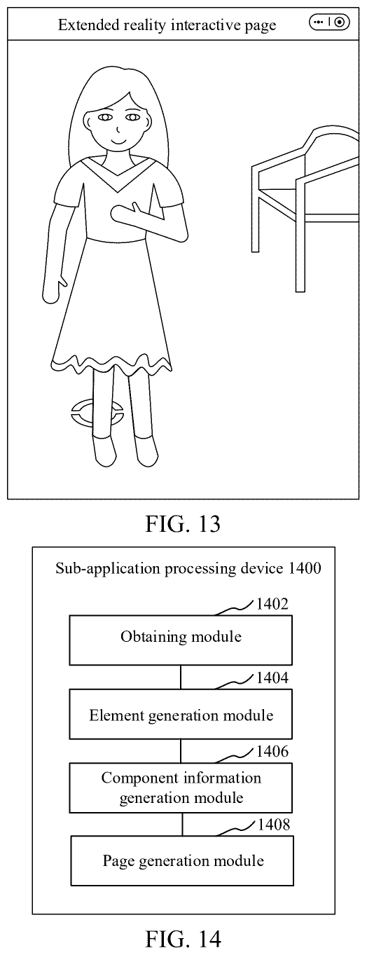

For the developer, there is almost no difference between an entire development procedure and a procedure of developing a common small program. However, because a written label is a predefined xr label, by using the wxml file shown in FIG. 11 and the js file shown in FIG. 12, a three-dimensional effect that integrates a three-dimensional virtual object and a real scenario may be presented, as shown in FIG. 13.

Although the steps in the flowcharts involved in the foregoing embodiments are displayed in sequence based on indication of arrows, but the operations are not necessarily performed sequentially according to a sequence indicated by the arrows. Unless otherwise explicitly specified in this disclosure, execution of the steps is not strictly limited, and the steps may be performed in other sequences. Moreover, at least some of the steps in the flowcharts involved in the embodiments above may include multiple steps or multiple stages. The steps or stages are not necessarily performed at the same moment but may be performed at different moments. Execution of the steps or stages is not necessarily sequentially performed, but may be performed alternately or interchangeably with other steps or at least some of steps or stages of other steps.

Based on a same inventive concept, the embodiments of this disclosure further provide a sub-application processing device for implementing the above-mentioned sub-application processing method. Implementation solutions provided by the device for resolving problems are similar to the implementation solutions described in the foregoing method. Therefore, for specific limitations in one or more sub-application processing device embodiments provided below, refer to the limitations on the sub-application processing method in the foregoing descriptions. Details are not described herein again.

In one embodiment, as shown in FIG. 14, a sub-application processing device is provided, including: an obtaining module 1402, an element generation module 1404, a component information generation module 1406 and a page generation module 1408, where:
the obtaining module 1402 is configured to obtain a page structure file corresponding to a sub-application, where the page structure file is configured for describing a structure of an extended reality interactive page to be generated for the sub-application;
the element generation module 1404 is configured to: parse the page structure file to obtain a predefined label in the page structure file, and convert the predefined label into an element in an extended reality interactive framework;
the component information generation module 1406 is configured to: obtain attribute information corresponding to the predefined label from the page structure file; and for each predefined label, convert the attribute information corresponding to the predefined label into component information bound to the element converted from the predefined label; and
the page generation module 1408 is configured to generate the extended reality interactive page for the sub-application based on the element in the extended reality interactive framework and the component information bound to the element, where the extended reality interactive page is configured for displaying interactions between a real scene and a virtual scene, and the sub-application is run on a parent application.

In this embodiment, by obtaining the page structure file corresponding to the sub-application, and the obtained page structure file is configured for describing the structure of the extended reality interactive page to be generated for the sub-application, the page layout of the sub-application page to be generated can be known through the page structure file. The page structure file is parsed to obtain each predefined label in the page structure file. The obtained predefined label is predefined by the user and can be converted into a label used in the extended reality interactive framework. In this way, each predefined label can be converted into an element in the extended reality interactive framework. Obtain attribute information corresponding to each predefined label from the page structure file. For each predefined label, convert the attribute information corresponding to the predefined label into component information bound to the element converted from the predefined label. In this way, both the predefined label and the corresponding attribute information in the page structure file can be converted into the element and the component information in the extended reality interactive framework. In addition, the corresponding relationship between each element and each piece of component information in the extended reality interactive framework follows the direct corresponding relationship between the predefined label and the attribute information in the page structure file. Based on each element in the extended reality interactive framework and the component information bound to each element, the extended reality interactive page for the sub-application is generated. In this way, the creation of the sub-application of the extended reality interactive class can be enabled through the extended reality interactive framework itself, without the need to introduce a third-party tool for processing. As a result, the development of the sub-application of the extended reality interactive class is made easier. It effectively lowers a threshold for developers to get started with the development of the sub-application of the extended reality interactive class. In addition, the extended reality interactive page provides the interactions between the real scene and the virtual scene. In this way, the sub-application can bring a human-machine interactive environment combining the scene with virtuality to the user.

In one embodiment, attribute information corresponding to a predefined label includes a label attribute corresponding to the predefined label, and attribute data corresponding to the label attribute; and component information bound to each element, including a component associated with each element, and component configuration data bound to the component.

In this embodiment, each predefined label in the page structure file is converted into an element in the extended reality interactive framework, the label attribute corresponding to the predefined label is converted into a component associated with the element, and the attribute data corresponding to the label attribute is converted into the component configuration data bound to the component. In this way, various parts of the structure describing the extended reality interactive page can be converted into the extended reality interactive framework, so that the extended reality interactive page can be directly generated by using the elements, components and component configuration data through the extended reality interactive framework subsequently. As a result, the development of the sub-application of the extended reality interactive class can be realized without additional processing by the third-party. It lowers the development threshold for the sub-application of the extended reality interactive class.

In one embodiment, the component information generation module 1406 is further configured to generate attribute addition instructions for the component in the extended reality interactive framework based on the label attribute corresponding to each predefined label. The component matching each label attribute is obtained from the component library of the extended reality interactive framework based on the attribute addition instructions. For each label attribute, the component matching the label attribute is associated with the element converted from the predefined label corresponding to the label attribute. The component configuration data bound to the component matching the label attribute is generated based on the attribute data corresponding to the label attribute.

In this embodiment, based on the label attribute corresponding to each predefined label, the attribute addition instructions for the component in the extended reality interactive framework are generated, to obtain the component matching each label attribute from the component library of the extended reality interactive framework based on the attribute addition instructions. In this way, the label attribute in the page structure file can be converted into the corresponding component in the extended reality interactive framework. For each label attribute, the component matching the label attribute is associated with the element converted from the corresponding predefined label, so that the corresponding relationship between the component and the element is consistent with the corresponding relationship between the predefined label and the label attribute, to ensure the accuracy of the converted data.

In one embodiment, the extended reality interactive framework includes a plurality of systems, each of the systems corresponds to at least one component, and each of the systems is configured to process component configuration data of the corresponding component.

The page generation module 1408 is further configured to determine the system corresponding to each component in the extended reality interactive framework; for each component, transmit the component configuration data bound to the component to the system corresponding to the component; and drive each system to perform processing of the received component configuration data to form corresponding page content, to obtain the extended reality interactive page for the sub-application.

In this embodiment, the extended reality interactive framework includes a plurality of systems, and each of the systems corresponds to at least one component. In addition, each of the systems can process component configuration data of the corresponding component. After converting each predefined label, the label attribute corresponding to the predefined label, and the attribute data corresponding to the label attribute in the page structure file into each element, the component associated with the element, and the component configuration data bound to the component in the extended reality interactive framework, the system corresponding to each component in the extended reality interactive framework is determined, to accurately determine which components need to be sent to which system for processing. As a result, for each component, the component configuration data bound to the component is sent to the system corresponding to the component. Drive each of the systems to perform processing of received component configuration data, so that corresponding page content can be formed through the processing of the corresponding component configuration data by each system. In this way, a subroutine of the extended reality interactive class can be built directly in the extended reality interactive framework without using external tools. The cost of developing the subroutine of the extended reality interactive class is reduced, and the efficiency of the subroutine of the extended reality interactive class is improved.

In one embodiment, the page generation module 1408 is further configured to: obtain a sub-reference code of each system in the extended reality interactive framework; for each component, fill the component configuration data bound to the component into the sub-reference code of the system corresponding to the component, to obtain a component code; and drive each of the systems to run a component code of each of the systems to form the corresponding page content, to obtain the extended reality interactive page for the sub-application.

In this embodiment, the sub-reference code of each system in the extended reality interactive framework is obtained. For each component, the component configuration data bound to the component is filled into the sub-reference code of the system corresponding to the component, to obtain the component code. In this way, the corresponding component code can be automatically generated without the need for the user to write the code. Each of the systems is driven to run a component code of each of the systems to form the corresponding page content, to obtain the extended reality interactive page for the sub-application. In this way, a user-defined sub-application of the extended reality interactive class can be built, which can shorten the development cycle and improve the development efficiency. Moreover, through the addition of elements and components, as well as the binding of component configuration data, the user who knows little about the development of the sub-application of the extended reality interactive class can also complete the development of various parts and functions of the sub-application, making the development of the sub-application of the extended reality interactive class easier.

In one embodiment, the plurality of systems include a rendering system, and each of the components includes at least a component corresponding to the rendering system.

The page generation module 1408 is further configured to: obtain page rendering data from the component configuration data bound to the component corresponding to the rendering system; transmit the page rendering data to the rendering system; and control the rendering system to perform page rendering based on the page rendering data to form the corresponding page content, to obtain the extended reality interactive page for the sub-application.

In this embodiment, obtain the page rendering data from the component configuration data bound to the component corresponding to the rendering system; transmit the page rendering data to the rendering system; and control the rendering system to perform page rendering based on the page rendering data, to form the corresponding page content. In this way, when developing the sub-application of the extended reality interactive class, it is not necessary to rely on third-party rendering engines, but can perform the page rendering directly by the rendering system of the extended reality interactive framework, which is convenient for the developers who do not know the relevant knowledge of the third-party rendering engines to realize the development of the sub-application of the extended reality interactive class. This lowers the threshold for developing the sub-application of the extended reality interactive class.

In one embodiment, the plurality of systems further include an animation system. Each component further includes a component corresponding to the animation system. The page generation module 1408 is further configured to obtain animation data from the component configuration data bound to the component corresponding to the animation system, and transmit the animation data to the animation system. The rendering system is controlled to perform page rendering based on the page rendering data, and the animation system is controlled to generate animation content based on the animation data, to form page content including the animation content. In this way, the extended reality interactive page for the sub-application is obtained.

In this embodiment, the plurality of systems further include an animation system. Each component further includes a component corresponding to the animation system. Animation data is obtained from component configuration data bound to the component corresponding to the animation system, and the animation data is sent to the animation system. The rendering system is controlled to perform page rendering based on the page rendering data, and the animation system is controlled to generate the animation content based on the animation data to generate the dynamic page content and the static page content. In this way, when developing the sub-application of the extended reality interactive class, it is not necessary to rely on third-party related engines, but can perform the page rendering and animation generation directly by the rendering system and the animation system in the extended reality interactive framework. This makes it possible for the developers to develop the sub-application of the extended reality interactive class without the relevant knowledge of the third-party related engines, thus lowering the threshold for developing the sub-application of the extended reality interactive class.

In one embodiment, the element generation module 1404 is further configured to generate element creation instructions for the extended reality interactive framework based on each predefined label; and based on the element creation instructions, obtain an element matching each predefined label from an element library of the extended reality interactive framework.

In this embodiment, based on each predefined label, generate the element creation instructions for the extended reality interactive framework, to obtain the element matching each predefined label from the element library of the extended reality interactive framework based on the element creation instructions. In this way, each predefined label in the page structure file can be accurately converted into an element in the extended reality interactive framework.

In one embodiment, the page generation module 1408 is further configured to: obtain a reference framework code corresponding to the extended reality interactive framework; and based on the element in the extended reality interactive framework, and the component information bound to the element, adjust the reference framework code to obtain a page framework code of the sub-application, the page framework code of the sub-application being configured for generating the extended reality interactive page for the sub-application.

In this embodiment, obtain a reference framework code corresponding to the extended reality interactive framework. Based on the element in the extended reality interactive framework, and the component information bound to the element, adjust the reference framework code to obtain a page framework code of the sub-application. In this way, a user-defined sub-application of the extended reality interactive class can be generated automatically without the need for the user to write the code, which can shorten the development cycle and improve the development efficiency. Moreover, through the addition of elements and components, as well as the binding of component configuration data, the user who does not know how to code can also develop the sub-application on his or her own, making the development of the sub-application easier.

In one embodiment, the device further includes an interactive module. The interactive module is configured to: call a camera in the extended reality interactive page to capture a real scene through the camera; obtain pre-stored three-dimensional model material, and generate a three-dimensional virtual object based on the three-dimensional model material; and synthesize the real scene with the three-dimensional virtual object, and display an enhanced scene image obtained through synthesis in the extended reality interactive page.

In this embodiment, call a camera in the extended reality interactive page to capture a real scene through the camera; obtain pre-stored three-dimensional model material, and generate a three-dimensional virtual object based on the three-dimensional model material; and synthesize the real scene with the three-dimensional virtual object. In this way, an enhanced scene image obtained through synthesis can be displayed in the sub-application, and the scene image combining the reality and the virtuality can be presented through the sub-application, so that the sub-application of the extended reality interactive class provides the user with a function of combining a real environment and a virtual environment, and expands the interactive capability of the sub-application.

In one embodiment, the interactive module is configured to: obtain pose information of the camera, and generate a virtual scene matching the real scene based on the pose information of the camera; and integrate the three-dimensional virtual object into the virtual scene, to obtain the enhanced scene image displayed in the extended reality interactive page.

In this embodiment, the pose information of the camera is obtained. A virtual scene matching the real scene is generated based on the pose information of the camera, to integrate the three-dimensional virtual scene into the virtual scene and obtain the enhanced scene image displayed in the extended reality interactive page. In this way, virtual content can be superimposed on the real scene captured by the camera in real time and the virtual content can be seamlessly combined with the real environment, producing a visual effect that confuses the real with the fake.

The modules in the foregoing sub-application processing device may be implemented in whole or in part by software, hardware, and a combination thereof. The modules may be built in or stand alone from a processor in a computer apparatus in a form of hardware, or may be stored in a memory in a computer apparatus in a form of software, so that the processor can call and execute operations corresponding to the modules.

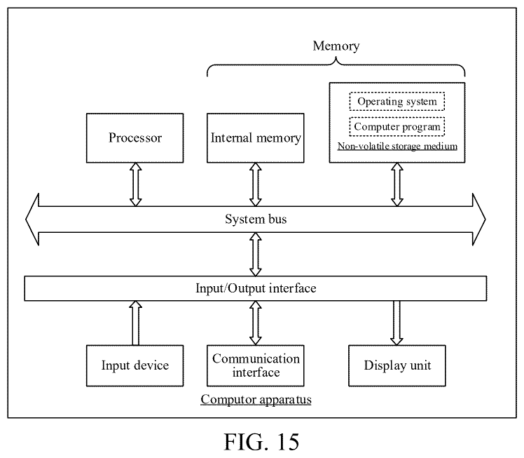

In one embodiment, a computer apparatus is provided. The computer apparatus may be a terminal or a server. Using the terminal as an example, a diagram of an internal structure of the terminal may be shown in FIG. 15. The computer apparatus includes a processor, a memory, an input interface, an output interface, a communication interface, a display unit, and an input device. The processor, the memory, the input interface, and the output interface are connected through a system bus, and the communication interface, the display unit, and the input device are connected to the system bus through the input interface and the output interface. The processor of the computer apparatus is configured to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The input interface and the output interface of the computer apparatus are configured to exchange information between the processor and an external apparatus. The communication interface of the computer apparatus is configured to communicate with an external terminal in a wired or wireless manner. The wireless manner may be implemented by WI-FI, a mobile cellular network, near field communication (NFC), or another technology. When the computer program is executed by the processor, a sub-application processing method is implemented. The display unit of the computer apparatus is configured to form a visually visible image and may be a display screen, a projection device, or a virtual reality imaging device. The display screen may be a liquid crystal display screen or an e-ink display screen. The input device of the computer apparatus may be a touch layer covering the display screen, or may be a button, a trackball, or a touchpad disposed on a housing of the computer apparatus, or may be an external keyboard, a touchpad, a mouse or the like.

It is noted that, the structure shown in FIG. 15 is merely a block diagram of a part of a structure related to a solution of this disclosure and does not limit the computer apparatus to which the solution of this disclosure is applied. Specifically, the computer apparatus may include more or fewer components than those in the drawings, or some components are combined, or a different component arrangement is used.

In one embodiment, a computer apparatus is further provided, including a memory and a processor. The memory stores a computer program. The computer program, when executed by the processor, implements operations of the foregoing method embodiments.

In one embodiment, a computer-readable storage medium is provided, having a computer program stored therein. The computer program, when executed by a processor, implements operations of the foregoing method embodiments.

In one embodiment, a computer program product is provided, including a computer program. The computer program, when executed by a processor, implements operations of the foregoing method embodiments.

It is noted that all or some of procedures of the method in the foregoing embodiments may be implemented by a computer program instructing relevant hardware. The computer program may be stored in a non-volatile computer-readable storage medium. When the computer program is executed, the procedures of the foregoing method embodiments may be included. Any references to memories, databases or other media provided in this disclosure and used in embodiments may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random access memory (MRAM), a ferroelectric random access memory (FRAM), a phase change memory (PCM), a graphene memory, and the like. The volatile memory may include a random access memory (RAM), an external cache or the like. For the purpose of illustration but not limitation, RAM is available in many forms, for example, static random access memory (SRAM), dynamic random access memory (DRAM), or the like. The databases involved in various embodiments provided in this disclosure may include at least one of a relational database and a non-relational database. The non-relational database may include, but is not limited to, a blockchain-based distributed database and the like. The processors involved in the various embodiments provided by this disclosure can be general-purpose processors, central processing units, graphics processors, digital signal processors, programmable logic devices, data processing logic devices based on quantum computing, and are not limited thereto.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Technical features of the foregoing embodiments may be combined in various manners. To make the description concise, not all possible combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of this disclosure. Transformations and improvements can be made without departing from the scope of this disclosure. These transformations and improvements belong to the protection scope of this disclosure.

What is claimed is:

1. A method of sub-application processing, the method comprising:
obtaining a page structure file for a sub-application, the page structure file describing a structure of an extended reality interactive page to be generated for the sub-application;
parsing the page structure file to obtain one or more predefined labels, the one or more predefined labels respectively including an indicator of extended reality;
converting the one or more predefined labels respectively into one or more elements in an extended reality interactive framework;
obtaining respective attribute information of the one or more predefined labels from the page structure file;
converting the respective attribute information of the one or more predefined labels into respective component information for the one or more elements in the extended reality interactive framework; and
generating the extended reality interactive page for the sub-application based on the one or more elements in the extended reality interactive framework and the respective component information for the one or more elements, the extended reality interactive page displaying interactions between a real scene and a virtual scene.

2. The method according to claim 1, wherein:
the respective attribute information of the one or more predefined labels comprises respective label attributes of the one or more predefined labels, and respective attribute data of the respective label attributes; and
the respective component information for the one or more elements comprises one or more components in a component library of the extended reality interactive framework that are respectively associated with the one or more elements, and respective component configuration data of the one or more components.

3. The method according to claim 2, wherein the converting the respective attribute information comprises:
generating attribute addition instructions based on the respective label attributes of the one or more predefined labels;
obtaining, based on the attribute addition instructions and from the component library of the extended reality interactive framework, the one or more components that match the respective label attributes of the one or more predefined labels;
establishing a respective association between the one or more components that match the respective label attributes of the one or more predefined labels and the one or more elements that are converted from the one or more predefined labels; and
generating, based on the respective attribute data of the respective label attributes, the respective component configuration data of the one or more components that match the respective label attributes.

4. The method according to claim 3, wherein:
the extended reality interactive framework comprises a plurality of systems respectively configured to process corresponding components; and
the generating the extended reality interactive page comprises:
determining one or more systems configured to process the one or more components;
transmitting the respective component configuration data of the one or more components to the one or more systems; and
driving the one or more systems to respectively perform processing of the respective component configuration data to generate page content of the extended reality interactive page for the sub-application.

5. The method according to claim 4, wherein the driving the one or more systems comprises:
obtaining respective sub-reference codes of the one or more systems in the extended reality interactive framework;
filling the respective component configuration data of the one or more components into the respective sub-reference codes of the one or more systems, to obtain respective component codes; and
driving the one or more systems to run the respective component codes to generate the page content.

6. The method according to claim 4, wherein:
the plurality of systems comprises at least a rendering system;
the transmitting the respective component configuration data comprises:
obtaining page rendering data from the respective component configuration data of a first component in the one or more components, the first component corresponding to the rendering system; and
transmitting the page rendering data to the rendering system; and
the driving the one or more systems comprises:
controlling the rendering system to perform page rendering based on the page rendering data to generate the page content.

7. The method according to claim 6, wherein:
the plurality of systems further comprises an animation system;
the transmitting the respective component configuration data comprises:
obtaining animation data from the respective component configuration data of a second component in the one or more components, the second component corresponding to the animation system, and
transmitting the animation data to the animation system; and
the driving the one or more systems comprises:
controlling the animation system to generate animation content based on the animation data; and
generating the page content comprising the animation content.

8. The method according to claim 1, wherein:
the converting the one or more predefined labels comprises:
generating element creation instructions for the extended reality interactive framework based on the one or more predefined labels;
based on the element creation instructions, obtaining the one or more elements that respectively match the one or more predefined labels from an element library for the extended reality interactive framework; and
adding the one or more elements to the extended reality interactive framework.

9. The method according to claim 1, wherein:
the generating the extended reality interactive page comprises:
obtaining a reference framework code corresponding to the extended reality interactive framework;
based on the one or more elements in the extended reality interactive framework and the respective component information for the one or more elements, adjusting the reference framework code to obtain a page framework code of the sub-application; and
generating the extended reality interactive page for the sub-application according to the page framework code.

10. The method according to claim 1, the method further comprising:
calling a camera to capture a real scene via the extended reality interactive page;
obtaining pre-stored three-dimensional model material;
generating a three-dimensional virtual object based on the pre-stored three-dimensional model material;
synthesizing the real scene with the three-dimensional virtual object to obtain an enhanced scene image; and
displaying the enhanced scene image in the extended reality interactive page.

11. The method according to claim 10, wherein:
the synthesizing comprises:
obtaining pose information of the camera;
generating a simulation scene that simulates the real scene based on the pose information of the camera; and
integrating the three-dimensional virtual object into the simulation scene, to obtain the enhanced scene image.

12. An information processing apparatus for sub-application processing, comprising processing circuitry configured to:
obtain a page structure file for a sub-application, the page structure file describing a structure of an extended reality interactive page to be generated for the sub-application;
parse the page structure file to obtain one or more predefined labels in the page structure file, the one or more predefined labels respectively including an indicator of extended reality;
convert the one or more predefined labels respectively into one or more elements in an extended reality interactive framework;
obtain respective attribute information of the one or more predefined labels from the page structure file;
convert the respective attribute information of the one or more predefined labels into respective component information for the one or more elements in the extended reality interactive framework; and
generate the extended reality interactive page for the sub-application based on the one or more elements in the extended reality interactive framework and the respective component information for the one or more elements, the extended reality interactive page displaying interactions between a real scene and a virtual scene.

13. The information processing apparatus according to claim 12, wherein:
the respective attribute information of the one or more predefined labels comprises respective label attributes of the one or more predefined labels, and respective attribute data of the respective label attributes; and
the respective component information for the one or more elements comprises one or more components in a component library of the extended reality interactive framework that are respectively associated with the one or more elements, and respective component configuration data of the one or more components.

14. The information processing apparatus according to claim 13, wherein the processing circuitry is configured to:
generate attribute addition instructions based on the respective label attributes of the one or more predefined labels;
obtain, based on the attribute addition instructions and from the component library of the extended reality interactive framework, the one or more components that match the respective label attributes of the one or more predefined labels;
establish a respective association between the one or more components that match the respective label attributes of the one or more predefined labels and the one or more elements that are converted from the one or more predefined labels; and
generate, based on the respective attribute data of the respective label attributes, the respective component configuration data of the one or more components that match the respective label attributes.

15. The information processing apparatus according to claim 14, wherein:
the extended reality interactive framework comprises a plurality of systems respectively configured to process corresponding components; and
the processing circuitry is configured to:
determine one or more systems configured to process the one or more components;
transmit the respective component configuration data of the one or more components to the one or more systems; and
drive the one or more systems to respectively perform processing of the respective component configuration data to generate page content of the extended reality interactive page for the sub-application.

16. The information processing apparatus according to claim 15, wherein the processing circuitry is configured to:
obtain respective sub-reference codes of the one or more systems in the extended reality interactive framework;
fill the respective component configuration data of the one or more components into the respective sub-reference codes of the one or more systems, to obtain respective component codes; and
drive the one or more systems to run the respective component codes to generate the page content.

17. The information processing apparatus according to claim 15, wherein:
the plurality of systems comprises at least a rendering system; and
the processing circuitry is configured to:
obtain page rendering data from the respective component configuration data of a first component in the one or more components, the first component corresponding to the rendering system;
transmit the page rendering data to the rendering system; and
control the rendering system to perform page rendering based on the page rendering data to generate the page content.

18. The information processing apparatus according to claim 17, wherein:
the plurality of systems further comprises an animation system; and
the processing circuitry is configured to:
obtain animation data from the respective component configuration data of a second component in the one or more components, the second component corresponding to the animation system;
transmit the animation data to the animation system;
control the animation system to generate animation content based on the animation data; and
generate the page content comprising the animation content.

19. The information processing apparatus according to claim 12, wherein:
the processing circuitry is configured to:
generate element creation instructions for the extended reality interactive framework based on the one or more predefined labels;
based on the element creation instructions, obtain the one or more elements that respectively match the one or more predefined labels from an element library for the extended reality interactive framework; and
add the one or more elements to the extended reality interactive framework.

20. A non-transitory computer-readable storage medium storing instructions which when executed by at least one processor cause the at least one processor to perform:
obtaining a page structure file for a sub-application, the page structure file describing a structure of an extended reality interactive page to be generated for the sub-application;
parsing the page structure file to obtain one or more predefined labels in the page structure file, the one or more predefined labels respectively including an indicator of extended reality;
converting the one or more predefined labels respectively into one or more elements in an extended reality interactive framework;
obtaining respective attribute information of the one or more predefined labels from the page structure file;
converting the respective attribute information of the one or more predefined labels into respective component information for the one or more elements in the extended reality interactive framework; and
generating the extended reality interactive page for the sub-application based on the one or more elements in the extended reality interactive framework and the respective component information for the one or more elements, the extended reality interactive page displaying interactions between a real scene and a virtual scene.
